(19) United States
(12) Patent Application Publication
(10) Pub. No.: US 2014/0322686 A1
(43) Pub. Date: Oct. 30, 2014

(54) METHODS FOR PROVIDING TELEMEDICINE SERVICES

(71) Applicant: Rehabtics LLC, Baltimore, MD (US)

(72) Inventor: Xiaoxu KANG, Baltimore, MD (US)

(73) Assignee: Rehabtics LLC, Baltimore, MD (US)

(21) Appl. No.: 14/266,314

(22) Filed: Apr. 30, 2014

Related U.S. Application Data
(60) Provisional application No. 61/817,737, filed on Apr. 30, 2013.

(51) Int. Cl. G06F 19/00

(52) U.S. Cl. CPC G06F 19/3481
USPC 434/247

(57) ABSTRACT

The present disclosure relates to the use of telemedicine software and/or games to meet rehabilitation or physical training needs. More specifically, the disclosure relates to methods and systems that motivate and guide users in the course of a program which takes place at an institution, where the user initiates recovery or training, and/or at home, when the user must maintain a rehabilitation or physical training schedule to fully recover or complete training.

### CROSS-REFERENCE TO RELATED APPLICATION

This application claims the priority to U.S. Provisional application for patent Ser. No. 61/817,737 filed on Apr. 30, 2013, the disclosure of which is incorporated herein by reference in its entirety.

### TECHNICAL FIELD

The present disclosure relates to the use of telemedicine software and/or games to meet rehabilitation or physical training needs. More specifically, the disclosure relates to methods and systems that conduct assessment, motivate, and guide users in the course of a program which takes place at an institution, where the user initiates recovery or training, and/or at home, when the user must maintain a rehabilitation or physical training schedule to fully recover or complete training

### BACKGROUND

Currently, a low treatment compliance rate exists among patient populations for at-home and other non-institutional rehabilitation programs. More specifically, the majority of patients fail to follow at-home, self-directed rehabilitation recommendations and, further, receive no feedback and guidance for the rehabilitation that they do follow through with. Because of low compliance rates, patients have slow recovery rates which, subsequently, lead to high re-admission rates, loss of productivity, and increased living dependency.

One reason why patients have low compliance rates is because physicians, therapists, and trainers have no way of tracking patients' at-home, self-directed rehabilitation progress except by in-person follow-up visits. Physicians, therapists, and trainers, therefore, have no way of providing feedback for the at-home rehabilitation that patients are completing. The end result of low treatment compliance rates is a re-occurrence of chronic diseases, subsequent hospital re-admissions, and increased indirect and direct medical costs.

For example, the total economic cost of stroke in the United States is $43 billion. Of this, $28 billion is due to the direct costs of initial hospitalization, rehabilitation, medical care, and physician payments. The remainder, $15 billion, is due to indirect costs such as loss of productivity, hospital readmission, and long-term medical care. Many patients who require long-term physical rehabilitation have suffered from neurological ailments, such as stroke, and develop depression due to loss of normal social identity.

In view of the low compliance rates for at-home rehabilitation programs and high costs associated with certain medical conditions that can be treated with at-home rehabilitation, there remains a need for methods of providing rehabilitation programs conducting assessment and promoting higher compliance rates by users. There also remains a need for methods or providing rehabilitation programs in which progress can be quantified and tracked easily by a patient and therapist/trainer and which a patient is motivated to complete.

### SUMMARY

The methods described herein overcome issues of patient motivation and compliance as well as issues related to measuring and tracking patient progress. Some embodiments of the methods describe how to provide telemedicine services for physical rehabilitation. They are concerned with increasing patient motivation, compliance, and rehabilitation quality in relation to rehabilitation for patients who require either short-term or long-term training at a location other than a hospital or clinic, as well as enabling physicians, therapists, trainers, and instructors to remotely track patient compliance.

Described herein are methods that solve the problems laid out above by enabling a trainer, user, or software program to, remotely or in the presence of a user, assess and measure a user's physical conditions, evaluate a user's training needs to determine initial parameters for exercises; select ideal movements/training targets/goals/movement targets to satisfy the initial parameters; display the ideal movements/training targets/goals/movement targets on a screen; capture motion sensing and tracking data from motion sensing and tracking device(s) used to track the user's movements; process, log, and analyze the captured data; compare the user's movements to the ideal movements/training targets/goals/movement targets/training goals; and provide feedback of the results to the user. The methods described may be carried out using a software program/game wherein the user's movements are part of the commands to play the software program/game.

Additionally, some embodiments of the methods described herein can be used for physical training, such as to learn or improve a fitness exercise or other physical skill-related action. This can be accomplished with a software program/game evaluating a user's needs, establishing parameters for the physical training, providing feedback to the user of a comparison between the user's movements and an ideal movement or training target/goal. This can also be accomplished with a trainer. For example, if a user wishes to be trained by a trainer, but is in a remote location compared to where the trainer or instructor is, a trainer or instructor can use the described methods to motivate and encourage the user to continue a program as well as to track the user's progress and remotely make changes to the program.

The methods described herein can take place at an institution such as, but not limited to, a physical rehabilitation clinic, rehabilitation hospital, intensive care unit, critical care unit, fitness gym, training center, senior living center, or other therapeutic clinic. The methods described herein can also take place at an individual space such, but not limited to, a user's residence, hotel room, or office.

### BRIEF DESCRIPTION OF THE DRAWINGS

FIG. 1 is a flow chart representing a method described herein.

FIG. 2 represents the automatic adjustments made by a software program based on a user's prior training sessions.

FIG. 3 represents the adjustments made by a trainer based on a user's prior training sessions.

### DETAILED DESCRIPTION

Various definitions are given below.

The term “EMR” as used herein refers to an electronic medical record. A “user's EMR,” as used herein, refers to an EMR that contains all of the user's medical records. The term “trainer's EMR” as used herein refers to a user's EMR that the trainer has access to, wherein the user is a user whom the trainer is training.

The term “trainer” as used herein refers to any person, other than the user, who may be guiding the user through the use of the method described herein such as, but not limited to, a physician, therapist, caregiver, athletic trainer, or instructor.

The term “user” as used herein refers to any person such as, but not limited to, a therapy patient, an elder person, a person having a condition, injury, and/or disease that can be treated with physical therapy, or an athlete who may be using the method to improve that person's physical ability and skills.

The term “evaluate” as used herein may refer to the action of a trainer or software program observing and measuring/assessing a user's current performance and progress in therapy or training and using those observations and measurements to determine, or set, parameters that will allow the user to progress further along in the user's therapy or training program.

The term “parameter” as used herein may refer to, but is not limited to, a constraint on the types of movements, an angle of motion for a movement, number of repetitions for each movement, duration to be spent completing each movement, duration to be spent completing all movements in one session, desired velocity, desired movement patterns, and desired acceleration and endurance.

The term “select” as used herein may refer to an action taken by a trainer or user to choose an exercise among provided exercise options that results in a customized therapy or training protocol which is based on the parameters established by the trainer, user, or software program.

The term “screen” as used herein may refer to a visual display on an object such as, but not limited to, a television, computer, netbook, tablet, smartphone, or on a wall if displayed by a projector.

The term “process” as used herein may refer to the procedure of receiving the data captured from one, multiple, and/or all sensors and transforming it so that it is in a medium that is understandable to the average person. For example, processed data may include, but is not limited to, data in numerical form that indicates at what time the user completed each targeted movement, data that gives a numerical value for a joint angle of each attempted targeted movement, data that gives a numerical value for a movement trajectory of each attempted targeted movement, data that gives a numerical value for blood pressure during each second of activity, or data that gives a time for duration of activity.

The term “log” as used herein may refer to taking processed data and saving it in a user's EMR, a user's individual account, a trainer's EMR, or a trainer's individual account.

The term “analyze” as used herein may refer to modifying processed data or a summary of processed data in a way that enables the trainer or user to track the user's previous activity and evaluate the user's progress. For example, analyzed data may be data that is communicable to the trainer or user such as, but not limited to, the total number of correct repetitions a user completed in one session, the duration of time the user spent exercising in one session, the extent to which the user completed ideal movements or training targets/goals properly, the average angle of the user's motion in one session, an assessment of similarities and differences between two or more sessions of the user's average angle of motion, and an assessment of similarities and differences between two or more sessions of the user's number of correct repetitions in each session. Analyzed data may also be saved in a user's EMR, a user's individual account, a trainer's EMR, or a trainer's individual account.

The term “compare” as used herein refers to the process of contrasting the user's performed movements to the ideal movements or training targets/goals. This can be done by, for example, taking the total number of correct repetitions a user completed in one session and contrasting it to the number of correct repetitions that the user was supposed to complete. A comparison may show whether the user completed the correct number of repetitions, or whether the user completed fewer or more than the correct number of repetitions. A comparison can also be done by, for example, taking the angle of a user's motion in one attempt, taking the angle of ideal motion, and observing whether or not the angle of the user's motion was smaller, larger, or the same as the angle of the ideal motion.

The term “provide feedback” as used herein describes the action of a trainer, software program, or sensors sharing results from the user's completed exercise or exercises using visual means, auditory means, mechanical means, electrical means, or any combination thereof. Visual means may include, but are not limited to, videos, graphs, charts, raw data, emails, text messages, and display of a user's avatar on the screen reflecting the user's movements. Auditory means may include, but are not limited to, two-way discussions over the internet, two-way discussions over the phone, audio linked to a video, audio from a virtual instructor, recorded audio from a trainer, and live audio from a trainer. Mechanical means may include, but are not limited to, vibrations of sensors on or near the user's body. Electrical means may include, but are not limited to, electrical stimulation delivered from sensors to a user's body. Feedback given to a user may be provided in real-time, may be provided at a later time, or may be provided at both times. If a software program is providing feedback, that software program may be a software game being run on a gaming platform.

The term “gaming platform” as used herein may refer to, but is not limited to, a video game system, an online gaming system, desktop personal computer, laptop computer, netbook, tablet personal computer, ultra-mobile personal computer, pocket person computer, smartphone, or website browser.

The term “virtual instructor” as used herein refers to an image of an animated person, figure (such as virtual characters or object), or a person on the screen. This virtual instructor may communicate with the user using visual, mechanical, and/or auditory cues. For example, the virtual instructor may demonstrate an ideal movement or training target/goal to a user by visually demonstrating the ideal movement or training target/goal and verbally describing the movement or training target/goal. The virtual instructor may also, for example, provide instant feedback to a user and provide scores and virtual badges to a user.

The term “abnormal user behavior or performance” as used herein may refer to data collected that is related to user behavior or performance and where that data is not consistent with previously processed, logged, and analyzed data. For example, if a user has been gradually increasing the degree of angle for a specific movement and, in one training session, the user's angle for the movement decreases, the user's performance is abnormal. In another example, if a user's training session consistently takes a set period of time and if, in the next training session, the user takes a significantly longer or shorter period of time, the user's performance is abnormal. In a third example, if a user consistently performs exercise daily but misses more than two days in a row, the user's behavior is abnormal.

The term “physical training” can refer to learning and/or improving performance of a motion. The type of motion can include those related to physical therapy. The type of motion can also include those which a user desires new or improved performance. Examples of such motions include, but are not limited to fitness exercises and sports-related actions, and physical skill-related actions that have a preferred manner of performance, for example, as measured by a user's range of motion, movement trajectory, velocity, acceleration, joint angle, and duration.

A means for sensing optical, biological, or kinematic signals as used herein may refer to a sensor that can detect optical signals, biological signals, kinematic signals, or a combination thereof. For example, an optical sensor may detect an object, such as a person. A biological sensor may detect, for example, electromyography, heart rate, blood pressure, or skin conductance. A kinematic sensor may detect, for example, trajectory, velocity, acceleration, force, or orientation.

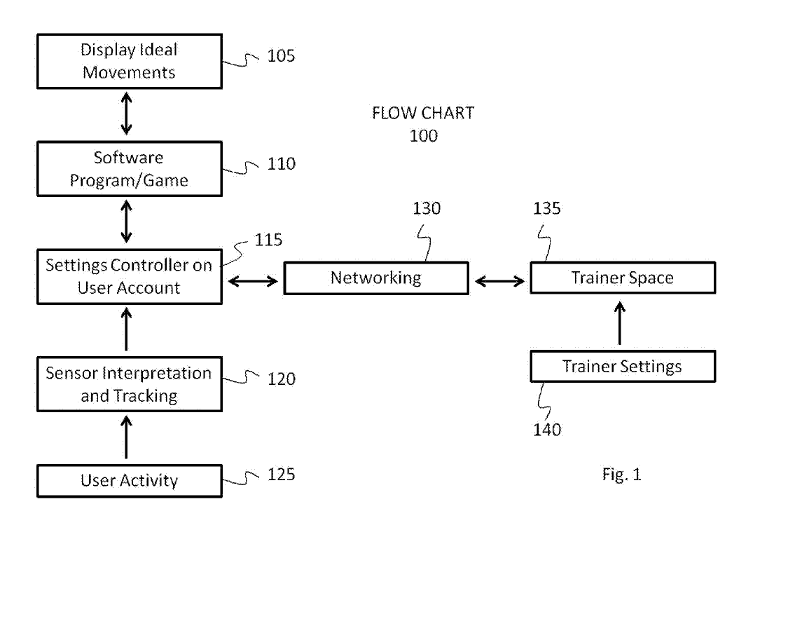

As shown in FIG. 1, the overall cyclical method can be seen in 100. A trainer may decide on settings such as parameters and ideal movements or training targets/goals for a user (140), send those settings to the trainer's EMR or individual account (135), and correspond with a user using networking between a trainer's EMR or individual account and a user's EMR or individual account (130). The trainer or user may then input the settings on the user's EMR or individual account (115) which may then send the settings to a software program or game (110). Alternatively, when the trainer inputs the settings to the trainer's EMR or individual account (135), those settings may automatically update in the user's EMR or individual account (115) through networking (130) and then be sent to a software program or game (110). The software program or game may display ideal movements or training targets/goals to the user on a screen (105). When the user performs the movements (125), at least one sensor will read the signals provided by the user and process (120) and log the data, wherein the logging of data ensures it ends up in the user's account (115). Once the data is in the user's account (115), the data may be analyzed. The trainer or software program may access this new data through networking of the accounts (130) and create new settings such as new parameters or ideal movements or training targets/goals which can be entered on the user's EMR or individual account (115). These new settings may be sent to the software program or game (110), which may display the ideal movements or training targets/goals to the user on a screen (105). The trainer may also meet with the user in person or online to determine new settings which would start the method from the beginning (140). This entire method can continue until the user has completed therapy or training.

The first exemplary embodiment of the methods described herein enables a trainer, remotely or in the presence of a user, or a user to evaluate a user's training needs to determine initial parameters for exercises; select ideal movements or training targets/goals to satisfy the initial parameters; display the ideal movements or training targets/goals on a screen; capture motion sensing and tracking data from a motion sensing and tracking device used to track the user's movements; process, log, and analyze the captured data; compare the user's movements to the ideal movements or training targets/goals; and provide feedback of the results to the user. The method can also include displaying the user's movements on the screen.

In the first exemplary embodiment described herein, the display of ideal movements or training targets/goals may be demonstrated by a virtual or live instructor. The display of ideal movements or training targets/goals may also be carried out by using an image or video of the desired movement focused on the body part or parts that are required to fulfill the movement, or full body movements.

In the first exemplary embodiment described herein, no equipment will need to be physically attached to the user. However, the user may use additional sensors that can be attached to, or held by, the user. These additional sensors can be used to track individual or combined inputs such as, but not limited to, electromyography, heart rate, blood pressure, skin conductance, trajectory, velocity, acceleration, or orientation. The data from the additional sensors may be processed, logged, and analyzed along with the data from the motion sensing and tracking device so that it may be used to display the user's movements on the screen and so that it may be used to compare the user's movements with the ideal movements or training targets/goals.

In the first exemplary embodiment described herein, the type of data captured may be, but is not limited to, movement data, activity data, and performance data. Movement data may include, but is not limited to, ranges of motion, movement trajectory, velocity, acceleration, joint angle, and duration. Activity data may include, but is not limited to, the time spent performing each movement and the time at which each movement was performed. Performance data may include, but is not limited to, scores, relative progress data, and achievements.

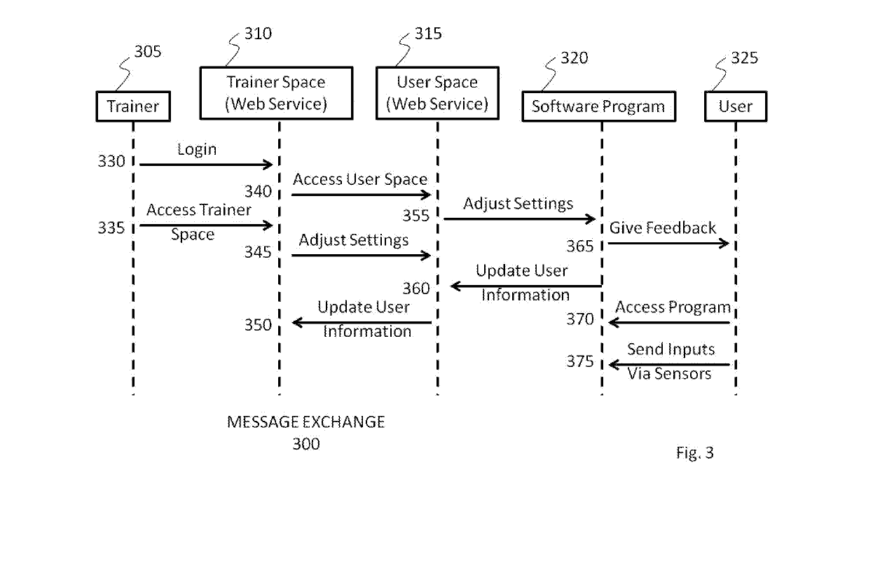

As shown in FIG. 3, in the first exemplary embodiment described herein, a message exchange can be used to communicate adjustments to settings such as parameters and ideal movements or training targets/goals between the trainer and the user through EMR or individual accounts (300). For example, the captured, processed, logged, and analyzed data from any sensors used by a user (325) may be first sent (375) to a software program (320). The software program (320) may then use the data to update user information (360) in a user's space (315), for example, a user's EMR and/or individual account, or/and to update user information (350) in a trainer's space (310), for example, a trainer's EMR and/or individual account, or any combination thereof. The trainer (305) may be able to login (330) to access the trainer's space (335) or to access the user's space (340). The data may be used by a trainer (305) to determine new settings such as new parameters and ideal movements or training targets/goals. A trainer (305) may then adjust the user's settings (345) from the trainer space (310) or adjust the user's settings (355) from the user's space (315) and send the new settings to the software program (320). Alternatively, a trainer (305) may communicate the new settings to the user (325) and the user (325) may then adjust the user's settings (355) from the user's space (315) and send the new settings to the software program (320). The new settings in the software program (320) may provide the new settings on a screen as a form of feedback (365) to the user (325).

The data may also be summarized in a report. The report may be sent to a trainer in order for the trainer to track the user's progress. Additionally, if the data that is captured, processed, logged, and analyzed represents abnormal user behavior or performance, an alert may be sent to a user's EMR, a user's individual account, other contact channels for the user such as, but not limited to, text messages, or to a user's trainer.

In the first exemplary embodiment described herein, the display of user's movements on the screen may be a display of the actual user. Alternatively, the display of the user's movements may be through the use of the user's avatar wherein the user's movements control the movement of the on-screen avatar.

In a second exemplary embodiment, a software game on a gaming platform may be used to enable a trainer, user, or software program to, remotely or in the presence of a user, evaluate a user's training needs to determine initial parameters for exercises; select ideal movements or training targets/goals to satisfy the initial parameters; display the ideal movements or training targets/goals on a screen; capture motion sensing and tracking data from a motion sensing and tracking device used to track the user's movements; process, log, and analyze the captured data; compare the user's movements to the ideal movements or training targets/goals; and provide feedback of the results to the user. The method can also include displaying the user's movements on the screen.

In the second exemplary embodiment described herein, the user's movements will be part of the commands to play the game.

In the second exemplary embodiment described herein, the display of ideal movements or training targets/goals may be demonstrated by a virtual or live instructor. The display of ideal movements or training targets/goals may also be carried out by using an image or video of the desired movement focused on the body part or parts that are required to fulfill the movement. The display of ideal movements or training targets/goals may also take place in the larger context of a software game.

In the second exemplary embodiment described herein, no equipment will need to be physically attached to the user. However, the user may use additional sensors that can be attached to, or held by, the user. These additional sensors can be used to track individual or combined inputs such as, but not limited to, electromyography, heart rate, blood pressure, skin conductance, trajectory, velocity, acceleration, or orientation. The data from the additional sensors may be processed, logged, and analyzed along with the data from the motion sensing and tracking device so that it may be used to display the user's movements on the screen and so that it may be used to compare the user's movements with the ideal movements or training targets/goals.

In the second exemplary embodiment described herein, the type of data captured may be, but is not limited to, movement data, activity data, and performance data. Movement data may include, but is not limited to, ranges of motion, movement trajectory, velocity, acceleration, joint angle, and duration. Activity data may include, but is not limited to, the time spent performing each movement and the time at which each movement was performed. Performance data may include, but is not limited to, scores, relative progress data, and achievements.

The captured data may be processed, logged, and analyzed. In one example of the use of captured, processed, logged, and analyzed data, the data may be used by the trainer to update the user's parameters and ideal movements or training targets/goals. The trainer may communicate these updates to the user so that the user may progress through the training program. In another example of the use of captured, processed, logged, and analyzed data, the data may be used by a software game to automatically update the user's parameters and ideal movements or training targets/goals and to display those new ideal movements or training targets/goals to the user in the next training session so that the user may progress through the training program. In a third example of the use of captured, processed, logged, and analyzed data, the data may be summarized in a report. The report may be sent to a trainer in order for the trainer to track the user's progress. Additionally, if the data that is captured, processed, logged, and analyzed represents abnormal user behavior or performance, an alert may be sent to a user's EMR, a user's individual account, other contact channels for the user such as, but not limited to, text messages, or to a user's trainer.

In the second exemplary embodiment described herein, the display of user's movements on the screen may be a display of the actual user. Alternatively, the display of the user's movements may be through the use of the user's avatar wherein the user's movements control the movement of the on-screen avatar.

In a third exemplary embodiment described herein, a software game on a gaming platform may be used to enable a trainer, user, or software program to, remotely or in the presence of a user, evaluate a user's training needs to determine initial parameters for exercises; select ideal movements or training targets/goals to satisfy the initial parameters; display the ideal movements or training targets/goals on a screen; capture motion sensing and tracking data from a motion sensing and tracking device used to track the user's movements; process, log, and analyze the captured data; compare the user's movements to the ideal movements or training targets/goals; provide feedback of the results to the user; and enable use of a social media component. The method can also include displaying the user's movements on the screen.

In the third exemplary embodiment described herein, the user's movements will be part of the commands to play the game.

In the third exemplary embodiment described herein, the display of ideal movements or training targets/goals may be demonstrated by a virtual or live instructor. The display of ideal movements or training targets/goals may also be carried out by using an image or video of the desired movement focused on the body part or parts that are required to fulfill the movement. The display of ideal movements or training targets/goals may also take place in the larger context of a software game.

In the third exemplary embodiment described herein, no equipment will need to be physically attached to the user. However, the user may use additional sensors that can be attached to, or held by, the user. These additional sensors can be used to track individual or combined inputs such as, but not limited to, electromyography, heart rate, blood pressure, skin conductance, trajectory, velocity, acceleration, or orientation. The data from the additional sensors may be processed, logged, and analyzed along with the data from the motion sensing and tracking device so that it may be used to display the user's movements on the screen and so that it may be used to compare the user's movements with the ideal movements or training targets/goals.

In the third exemplary embodiment described herein, the type of data captured may be, but is not limited to, movement data, activity data, and performance data. Movement data may include, but is not limited to, ranges of motion, movement trajectory, velocity, acceleration, joint angle, and duration. Activity data may include, but is not limited to, the time spent performing each movement and the time at which each movement was performed. Performance data may include, but is not limited to, scores, relative progress data, and achievements.

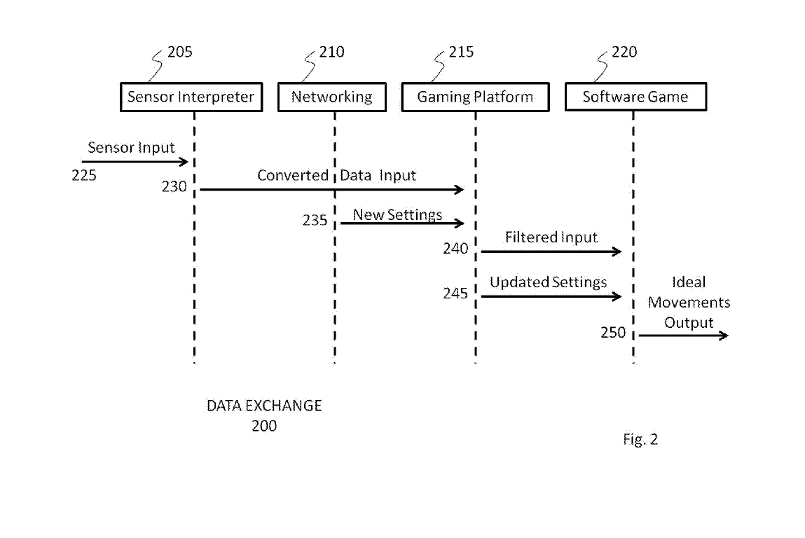

As shown in FIG. 2, adjustments to settings such as parameters and ideal movements or training targets/goals may occur automatically after data collection through the data exchange between sensors and a software game (200). For example, any used sensors may capture data (225). Using a sensor interpreter (205) and networking (210) between a user's EMR or individual account and a trainer's EMR or individual account, the captured data may be converted and inputted (230), wherein the data is processed, logged, and analyzed. Through the use of networking (210), for example, the assessment of overall changes in user performance between sessions to determine if the user is improving, the data may be used to automatically determine and set new settings (235), for example, parameters, and send the new settings to the gaming platform (215). The gaming platform will update the settings (245) in the software game (220) by filtering the inputted settings (240) so that the settings are transformed into what the user will recognize as ideal movements or training targets/goals. The software game (220) may then output the new ideal movements or training targets/goals (250) for the user.

In another example of the use of captured, processed, logged, and analyzed data, the data may be used by the trainer to update the user's parameters and ideal movements or training targets/goals. The trainer may communicate these updates to the user so that the user may progress through the training program. In a second example of the use of captured, processed, logged, and analyzed data, the data may be summarized in a report. The report may be sent to a trainer in order for the trainer to track the user's progress. Additionally, if the data that is captured, processed, logged, and analyzed represents abnormal user behavior or performance, an alert may be sent to a user's EMR, a user's individual account, other contact channels for the user such as, but not limited to, text messages, or to a user's trainer.

In the third exemplary embodiment described herein, the display of user's movements on the screen may be a display of the actual user. Alternatively, the display of the user's movements may be through the use of the user's avatar wherein the user's movements control the movement of the on-screen avatar.

In the third exemplary embodiment described herein, the social media component may be used to enable a user to connect with a trainer or other users through, for example, a social networking service, video chats, forums, and chat-rooms. One example of use of a social media component is where users may create a forum to share their goals and achievements in their individual fitness programs. Another example of use of a social media component is where a trainer and at least one user can use the social media component to hold a live video conference. The trainer may use the live video conference to teach one or many users ideal movements or training targets/goals, general fitness, or skills that require finesse. The trainer may also use the live video conference to diagnose and condition the user.

In the third exemplary embodiment described herein, the social media component may enable users to remotely use the software game together. For example, if there are multiple users logged in to software game at the same time, each individual user will see the other users as being logged in. Through the use of the social networking interface, any user can coordinate a game with one or more other users wherein all interested users can perform a game with specific movements together, but wherein the parameters will differ for each user according to individual physical training or rehabilitation needs.

In an example of use of the method for a stroke patient, a patient who has a stroke and is resuscitated in the hospital may be sent to an inpatient rehabilitation unit where the patient may initially do passive exercises, which involve a therapist lifting the patient's body to move and, eventually, may do active exercises wherein the patient can move without the therapist using the method described herein. For example, the therapist may initially evaluate the patient's physical therapy needs and choose varying movement types that are proper for the early rehabilitation of the patient. The therapist can set parameters for each movement such as, but not limited to, angle, duration, repetition, and frequency. The movements will be shown on a screen for the patient to mimic and data will be captured using at least one sensor. The patient's rehabilitation movements may be processed, logged, and analyzed. When the patient's health has improved enough, the patient will be moved into the outpatient rehabilitation unit. While in that unit, the patient may visit the therapist once or several times a week and the therapist may re-evaluate the patient using the patient's logged and analyzed data to determine new parameters and movements for the patient. Alternatively, a software program may re-evaluate the patient using the patient's logged and analyzed data to determine new parameters and movements for the patient. The patient may complete the new rehabilitation exercises during outpatient visits or at home. The patient's rehabilitation movements may continue to be processed, logged, and analyzed. Once the patient is released from the outpatient unit, the patient can continue to use the method at home. The therapist may log on to the patient's EMR or other individual account, where the data is saved, and may adjust parameters and movements based on the patient's progress. Alternatively, a software program may automatically adjust parameters and movements based on the patient's progress. The patient can then perform the exercises, and the data captured from a sensor can be processed, logged, and analyzed for the therapist to review. When needed, the therapist may adjust parameters and movements based on the patient's progress.

In another example, a patient who needs orthopedic surgery will first get the surgery and will then follow a similar process to the one above, wherein the orthopedic surgery patient will first use the method in an inpatient rehabilitation unit, will next use the method in an outpatient rehabilitation unit, and will then go home and continue using the method for at-home rehabilitation.

While the foregoing disclosure has been described in some detail for purposes of clarity and understanding, it will be appreciated by one skilled in the art from a reading of this disclosure that various changes in form and detail can be made without departing from the true scope of the disclosure and appended claims.

1. A method comprising the steps of:
evaluating a user's physical training or rehabilitation needs to determine initial parameters for an exercise;
selecting an ideal movement or a training target/goal to satisfy the initial parameters for the exercise;
displaying the ideal movement or the training target/goal on a screen;
capturing data of the user's movement with at least one sensor;
comparing the user's movement to the ideal movement or the training target/goal; and
providing feedback of the comparison to the user.

2. The method of claim 1, further comprising displaying the user's movement on the screen.

3. The method of claim 1, further comprising processing the data and optionally, logging the data and analyzing the data.

4-5. (canceled)

6. The method of claim 3, wherein a software program or game is used to carry out the method.

7. The method of claim 1, wherein the determination of ideal movement is done remotely or in the physical presence of the user.

8. The method of claim 1, wherein the display of ideal movements or training targets/goals is by a virtual instructor.

9. The method of claim 1, wherein said at least one sensor comprises a motion sensing and tracking device.

10. The method of claim 9, wherein said at least one sensor further comprises a means for sensing optical, biological, kinematic signals, or combinations thereof.

11. The method of claim 3, wherein the captured, processed, logged, and analyzed data is linked to, and saved in, a user's electronic medical record or individual account.

12. (canceled)

13. The method of claim 1, further comprising adjusting the parameters and ideal movements based on the data.

14. The method of claim 11, wherein the data is accessible to the user and the trainer.

15. The method of claim 14, wherein the data is summarized in a report to track the user's progress.

16. The method of claim 11, further comprising posting an alert of abnormal user behavior or performance to the user's or trainer's electronic medical record or individual account.

17. The method of claim 1, wherein the feedback provided is by the trainer.

18. The method of claim 1, wherein the feedback provided is by a software program.

19. The method of claim 17, wherein the feedback provided is in real-time.

20. The method of claim 17, wherein the feedback provided is visual, auditory, mechanical, or combinations thereof.

21. The method of claim 1, further comprising the user interacting with a trainer or other users with a social media component.

22. The method of claim 6, wherein multiple users can remotely play the software game together.

23-42. (canceled)

43. The method of claim 18, wherein the feedback provided is visual, auditory, mechanical, or combinations thereof.
